(19) United States
(12) Patent Application Publication
(10) Pub. No.: US 2018/0165522 A1
(43) Pub. Date: Jun. 14, 2018

(54) Target Object Recognition in Infrared Images

(71) Applicant: The Boeing Company, Chicago, IL (US)

(72) Inventors: Dmitriy V. Korchev, Irvine, CA (US); Yuri Owechko, Newbury Park, CA (US); Mark A. Curry, Lynnwood, WA (US)

(21) Appl. No.: 15/055,019

(22) Filed: Feb. 26, 2016

(51) Int. Cl. G06K 9/00; G06F 17/50; G06K 9/40; G06K 9/46

(52) U.S. Cl. CPC G06K 9/00771; G06K 9/4647; G06K 9/40; G06F 17/50

(57) ABSTRACT

A method and apparatus for recognizing target objects. The method comprises identifying a group of target objects in an image. Further, the method comprises forming a group of chips encompassing the group of target objects identified in the image. Yet further, the method comprises recognizing the group of target objects in the group of chips using a group of filters, wherein the group of filters was created using a group of models for reference objects and environmental information for a location where the group of target objects was located when the image was generated, wherein a filter in the group of filters comprises a group of reference images for a reference object in the reference objects.

### BACKGROUND INFORMATION

### 1. Field

The present disclosure relates generally to an improved target recognition system and, in particular, to a method and apparatus for recognizing target objects in infrared images.

### 2. Background

Infrared light is an invisible radiant energy that has wavelengths that are longer than those for visible light. For example, infrared light may have wavelengths from about 700 nm to about 1 mm.

Infrared light is used in many different applications. For example, infrared light may be used in industrial, scientific, medical, and other types of applications. For example, infrared camera systems may be used to perform target acquisition, surveillance, homing, tracking, and other operations.

With infrared cameras, infrared images may be generated and processed to detect and recognize target objects in the infrared images. For example, an automatic target recognition process may be used to recognize targets from infrared data in infrared images generated by the infrared cameras.

Currently used target recognition systems that recognize target objects in infrared data employ robust algorithms for target detection and recognition for various types of military and commercial platforms. The recognition of target objects may be used to track the target objects while performing various operations, such as surveillance or target object neutralization. It is desirable to reduce the number of false alarms when using target recognition systems for these and other types of operations.

These types of systems, however, may require extensive training in order to reduce false alarms while providing a desirable performance in recognizing objects. Therefore, it would be desirable to have a method and apparatus that take into account at least some of the issues discussed above, as well as other possible issues. For example, it would be desirable to have a method and apparatus that overcome a technical problem recognizing target objects in infrared images as accurately as desired when many different types of target objects are possibly present. As another example, it would also be desirable to have a method and apparatus that overcome a technical problem with the amount of training data needed to enable a target recognition system to perform in a manner that provides a desired level of target object recognition, while reducing false alarms when recognizing target objects in infrared images.

### SUMMARY

An embodiment of the present disclosure provides an apparatus. The apparatus comprises an object detector, a filter system, and an object identifier. The object detector identifies a group of target objects in an image and forms a group of chips encompassing the group of target objects identified in the image. The filter system includes a group of filters created using a group of models for a group of reference objects and environmental information for a location where the group of target objects was located when the image was generated, wherein a filter in the group of filters comprises a group of reference images for a reference object in the group of reference objects. The object identifier recognizes the group of target objects in the group of chips using the group of filters.

Another embodiment of the present disclosure provides a method for recognizing target objects. The method comprises identifying a group of target objects in an image. Further, the method comprises forming a group of chips encompassing the group of target objects identified in the image. Yet further, the method comprises recognizing the group of target objects in the group of chips using a group of filters, wherein the group of filters is created using a group of models for reference objects and environmental information for a location where the group of target objects was located when the image was generated, wherein a filter in the group of filters comprises a group of reference images for a reference object in the reference objects.

Yet another embodiment of the present disclosure provides an automatic object identifier system. The automatic object identifier system comprises a potential object detector, a preprocessor, a filter system, and an object identifier. The potential object detector receives an infrared image from a camera system and identifies a group of target objects in an image and forms a group of chips encompassing the group of target objects identified in the image. The preprocessor removes hot spots from the group of chips. The filter system receives the image from the preprocessor after the hot spots are removed from the group of chips and outputs a group of values from a group of filters for each chip in the group of chips, wherein the filter system includes the group of filters created using a group of models for reference objects and environmental information for a location where the group of target objects was located when the image was generated and wherein a filter in the group of filters comprises a group of reference images for a reference object in the reference objects. The object identifier recognizes a target object in the chip using the group of values output by the group of filters.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of a block diagram of a target object recognition environment in accordance with an illustrative embodiment;

FIG. 2 is an illustration of a block diagram of an image analyzer in accordance with an illustrative embodiment;

FIG. 3 is an illustration of a block diagram of reference images for a filter in accordance with an illustrative embodiment;

FIG. 4 is an illustration of pixel intensities including a hot spot in accordance with an illustrative embodiment;

FIG. 5 is an illustration of reference images in accordance with an illustrative embodiment;

FIG. 6 is an illustration of a flowchart of a process for recognizing a target object in accordance with an illustrative embodiment;

FIG. 7 is an illustration of a flowchart of a process for removing a hot spot in accordance with an illustrative embodiment;

FIG. 8 is an illustration of a flowchart of a process for creating reference images for reference objects in accordance with an illustrative embodiment;

FIG. 9 is an illustration of a flowchart of a process for processing a reference image in accordance with an illustrative embodiment;

FIG. 10 is an illustration of a flowchart of a process for adding a background to reference images in accordance with an illustrative embodiment;

FIG. 11 is an illustration of a flowchart of a process for processing a chip in a MACH filter in accordance with an illustrative embodiment;

FIG. 12 is an illustration of a flowchart of a process for recognizing a target object in accordance with an illustrative embodiment;

FIG. 13 is an illustration of pseudocode for removing non-zero values of pixels in a reference image in accordance with an illustrative embodiment; and

FIG. 14 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that object recognition systems that recognize targets in infrared data may be more complex, require more training than desired, and may not perform as accurately as desired.

For example, the amount of training data for classifiers in target object recognition systems is often more limited than desired. This situation often occurs for new types of target objects. The illustrative embodiments recognize and take into account that training data may be created from computer-aided design models of target objects to reduce the issue of the lack of actual field-collected data. The illustrative embodiments recognize and take into account, however, that creating infrared images may be more difficult than desired. The illustrative embodiments recognize and take into account that difficulty may occur through a complexity of a prediction of various types of target emissivity and reflectivity of infrared waves.

The illustrative embodiments recognize and take into account that an infrared image of a target object may change dramatically, depending on environmental conditions. The illustrative embodiments recognize and take into account that the environmental conditions, such as sun position, cloud cover, and other environmental factors, may cause the infrared image to change.

Thus, the illustrative embodiments provide a method and apparatus for recognizing target objects. The process begins by identifying a group of the target objects in an image. The image may be an infrared image or some other type of image. A group of chips encompassing the group of target objects identified in the image is formed. The group of the target objects in the group of chips is recognized using a group of filters. The group of filters is created using a group of models for reference objects and environmental information for a location where the group of target objects was located when the image was generated. A filter in the group of filters comprises a group of reference images for a reference object in the reference objects. In one example, the group of filters may be a maximum average correlation height filter.

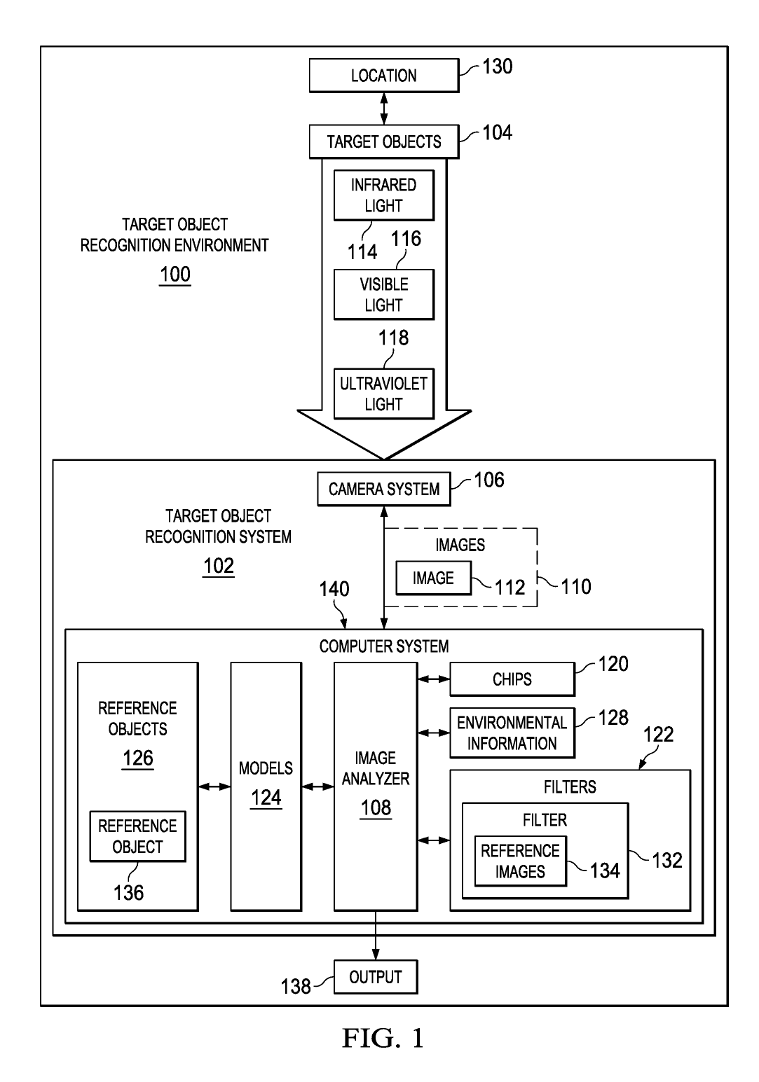

With reference now to the figures and, in particular, with reference to FIG. 1, an illustration of a block diagram of a target object recognition environment is depicted in accordance with an illustrative embodiment. In target object recognition environment 100, target object recognition system 102 operates to recognize target objects 104.

In this illustrative example, target object recognition system 102 includes camera system 106 and image analyzer 108. As depicted, camera system 106 generates images 110 for a group of target objects 104. Camera system 106 generates image 112 in images 110 by detecting at least one of infrared light 114, visible light 116, ultraviolet light 118, or some other suitable type of light.

As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, image analyzer 108 processes images 110. For example, image analyzer 108 identifies a group of target objects 104 in image 112. As used herein, “a group of”, when used with reference to items, means one or more items. For example, “a group of target objects 104” is one or more of target objects 104.

Image analyzer 108 forms a group of chips 120 encompassing the group of target objects 104 identified in image 112. In this illustrative example, a chip in chips 120 is a region within image 112. The region encompasses target objects 104. The region may be square, rectangular, circular, trapezoidal, irregular shaped, or some other suitable shape.

Image analyzer 108 creates a group of filters 122 using a group of models 124 for a group of reference objects 126 and environmental information 128 for location 130 where the group of target objects 104 was located when image 112 was generated. In the illustrative example, models 124 are electronic models used by a data processing system, such as a computer. Models 124 may be in the form of three-dimensional models. Models 124 may include mathematical representations of three-dimensional surfaces of an object. In these illustrative examples, models 124 may be, for example, computer-aided design (CAD) models.

As depicted, filter 132 in the group of filters 122 comprises a group of reference images 134 for reference object 136 in reference objects 126. In the illustrative example, reference object 136 may include more than one of filters 122. For example, two of filters 122 may correspond to reference object 136, five of filters 122 may correspond to reference object 136, or some other number of filters 122 may correspond to reference object 136.

Each filter may have a different viewpoint or a different range of viewpoints from another filter for reference object 136. When the viewpoints are defined as a range of angles, an overlap may be present between the ranges of angles between filters 122 for reference object 136 when more than one filter is present for reference object 136.

As depicted, image analyzer 108 recognizes the group of target objects 104 in the group of chips 120 using the group of filters 122. Image analyzer 108 generates output 138. Output 138 may include at least one of a group of classifications for the group of target objects 104, indications of a detection of the group of target objects 104 in image 112, a timestamp for image 112, or other suitable information. Output 138 may be sent to another computer system or device for use in targeting, tracking, or some other suitable purpose.

Image analyzer 108 in target object recognition system 102 may be implemented in software, hardware, firmware, or a combination thereof. When software is used, the operations performed by image analyzer 108 may be implemented in program code configured to run on hardware, such as a processor unit. When firmware is used, the operations performed by image analyzer 108 may be implemented in program code and data and stored in persistent memory to run on a processor unit. When hardware is employed, the hardware may include circuits that operate to perform the operations in image analyzer 108.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In this illustrative example, image analyzer 108 may be implemented in computer system 140. Computer system 140 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet, or some other suitable data processing system.

One or more technical solutions are present in the illustrative examples that overcome a technical problem with recognizing target objects 104 in infrared images in images 110 as accurately as desired when many different types of target objects 104 are possibly present. Additionally, one or more technical solutions are also present that overcome a technical problem with the amount of training data needed to enable a target recognition system to perform in a manner that provides a desired level of target object recognition, while reducing false alarms when recognizing target objects 104 in infrared images in images 110.

For example, one or more technical solutions include generating reference images 134 in a manner that takes into account environmental information 128. Environmental information 128 is environmental information about target object recognition environment 100 for location 130 where a group of target objects 104 was located when image 112, including the group of target objects 104, were generated.

As a result, one or more technical solutions may provide a technical effect in increasing the accuracy in recognizing target objects 104 in images 110, such as infrared images. Another technical effect may be present in which the amount of training data needed is reduced when reference images are generated using computer-aided design models, taking into account environmental information 128.

As a result, computer system 140 operates as a special purpose computer system in which image analyzer 108 in computer system 140 enables more accuracy in recognizing reference objects 126. In particular, image analyzer 108 transforms computer system 140 into a special purpose computer system, as compared to currently available general computer systems that do not have image analyzer 108.

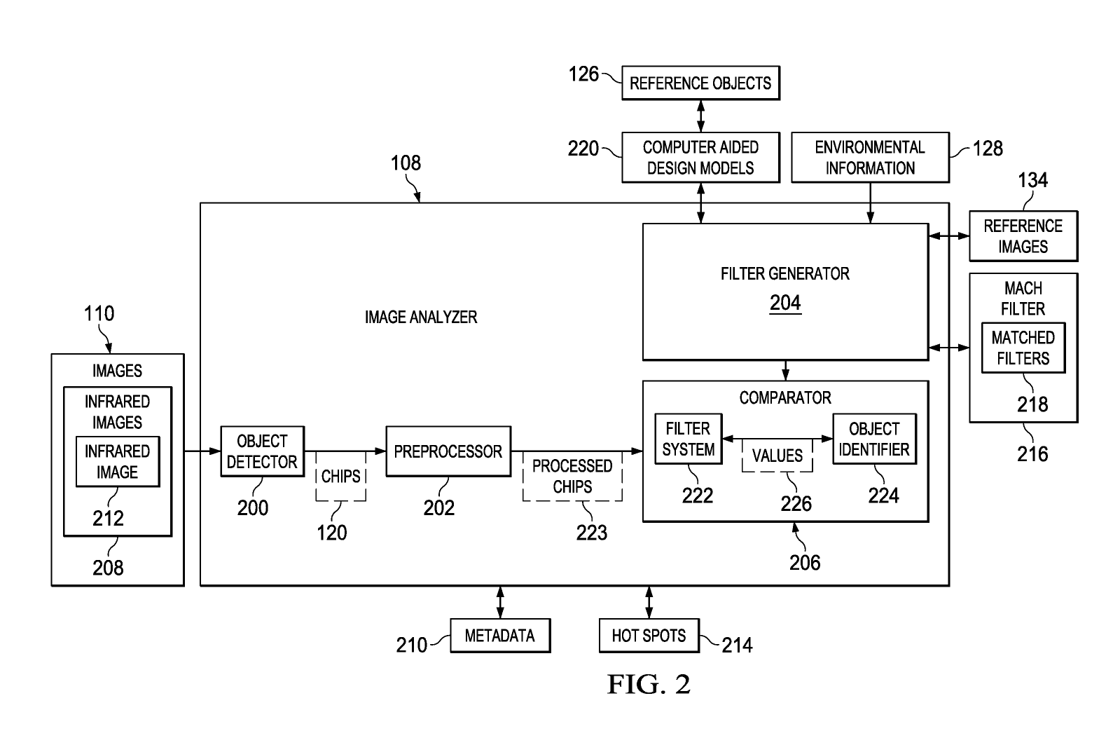

With reference now to FIG. 2, an illustration of a block diagram of an image analyzer is depicted in accordance with an illustrative embodiment. In the illustrative examples, the same reference numeral may be used in more than one figure. This reuse of a reference numeral in different figures represents the same element in the different figures.

Image analyzer 108 includes a number of different components. As depicted, image analyzer 108 includes object detector 200, preprocessor 202, filter generator 204, and comparator 206.

In this illustrative example, object detector 200 receives images 110 in the form of infrared images 208. Object detector 200 detects the presence of target objects 104, as shown in block form in FIG. 1, in infrared images 208. Object detector 200 may detect stationary objects and moving objects in target objects 104. Additionally, object detector 200 also may identify tracks for moving objects.

In this illustrative example, object detector 200 uses metadata 210 obtained from camera system 106, as shown in block form in FIG. 1, and sensors for a platform on which camera system 106 may be located. Metadata 210 may be selected from one of altitude, grazing angle, and other information used to estimate the size of the pixels in infrared images 208. With this information, the size of the object may be identified in determining whether the object is a target object for recognition. In particular, a determination is made as to whether the size of the object is close enough to the size of a target object for recognition.

In one illustrative example, when reference images 134 are created, the scales may be selected to be from 0.9 to 1.1. Pixel resolution is known for reference images 134. Metadata 210 is used to ensure that chips 120 extracted from infrared images 208 have a resolution similar to those in reference images 134, resulting in target objects 104, as shown in block form in FIG. 1, in chips 120 having sizes close to the those in reference images 134.

When object detector 200 identifies a group of target objects 104 in infrared image 212, object detector 200 forms a group of chips 120. The group of chips 120 is for regions within infrared image 212 that encompass the group of target objects 104. Each chip includes one of the groups of target objects 104. Object detector 200 sends the group of chips 120 to preprocessor 202.

In this illustrative example, preprocessor 202 operates to remove hot spots 214 from the group of chips 120 prior to the group of chips 120 being processed by comparator 206. In other words, preprocessor 202 removes hot spots 214 when hot spots 214 are present in the group of chips 120.

Hot spots 214 are areas that have a higher intensity than surrounding areas which are not indicative of features for a target object. For example, a hot spot may be a reflection, exhaust, or some other area of higher intensity on or near the target object that does not aid in the recognition of the target object. In many cases, a hot spot may result in an inability to correctly recognize the target object.

In this illustrative example, filter generator 204 creates maximum average correction height (MACH) filter 216 that is used for recognizing target objects 104, as shown in block form in FIG. 1. MACH filter 216 is an example of an implementation for filters 122, as shown in block form in FIG. 1. MACH filter 216 includes matched filters 218, which are examples of filters 122. As depicted, a matched filter is obtained by a known signal, or template. In the illustrative examples, applying the matched filter to an unknown signal is the same as applying correlation to detect the presence of the template in the unknown signal.

As depicted, MACH filter 216 is created by using computer-aided design (CAD) models 220. Computer-aided design models 220 are examples of implementations for models 124, as shown in block form in FIG. 1. For example, filter generator 204 generates reference images 134 for reference objects 126 in models 124.

Reference images 134 are used to form MACH filter 216. For example, a first group of matched filters 218 is formed using a first group of reference images 134 for a first reference object in reference objects 126. A second group of matched filters 218 is formed using a second group of reference images 134 for a second reference object in reference objects 126. In other words, each of reference objects 126 may have more than one matched filter in matched filters 218. Matched filters 218 form MACH filter 216. In other words, MACH filter 216 is formed from matched filters 218 for reference objects 126.

In these illustrative examples, filter generator 204 also generates reference images 134 from computer-aided design models 220 using environmental information 128. The use of environmental information 128 increases the likelihood that target objects 104, as shown in block form in FIG. 1, in images 110 may be correctly recognized by image analyzer 108, as shown in block form in FIG. 1. In this illustrative example, environmental information 128 takes into account the effects on infrared images 208 caused by various environmental conditions that are present in location 130, as shown in block form in FIG. 1, where target objects 104 were located at the time that infrared images 208 were generated.

Environmental information 128 includes at least one of sun position, cloud cover, ceiling height, rain, snow, humidity, smoke, haze, or other suitable environmental factors. This information is used to control how the model is rendered so that the positions of shadows and bright regions are as close as possible to how the target object would appear when viewed under the same conditions. For example, reference images 134 may be generated using a light source that simulates the position of the sun relative to target objects 104, as shown in block form in FIG. 1, in infrared images 208. The position of the sun is identified in environmental information 128.

In other words, filter generator 204 creates MACH filter 216 using computer-aided design models 220 for reference objects 126 and environmental information 128 for location 130, as shown in block form in FIG. 1, where a group of target objects 104 was located when image 112, as shown in block form in FIG. 1, was generated. Environmental information 128 may take into account the location of camera system 106, as shown in block form in FIG. 1, relative to target objects 104, as shown in block form in FIG. 1. As depicted, MACH filter 216 is used in filter system 222. MACH filter 216 in filter system 222 receives processed chips 223 from preprocessor 202. Filter system 222 outputs values 226 that are used by object identifier 224 to classify target objects 104.

For example, each group of matched filters 218 in MACH filter 216 corresponds to a reference object in reference objects 126, as shown in block form in FIG. 1. The matched filter in matched filters 218 outputting the highest value in values 226 may represent a recognition that the target object is a reference object corresponding to the matched filter outputting the highest value in values 226. If the value is greater than a threshold value, object identifier 224 classifies the target object in that chip as being the reference object for the matched filter outputting the highest value. Object identifier 224 may be implemented using currently available classifiers for recognizing target objects. On the other hand, if the highest value is not greater than a threshold value, object identifier 224 classifies the target object as unknown in this illustrative example.

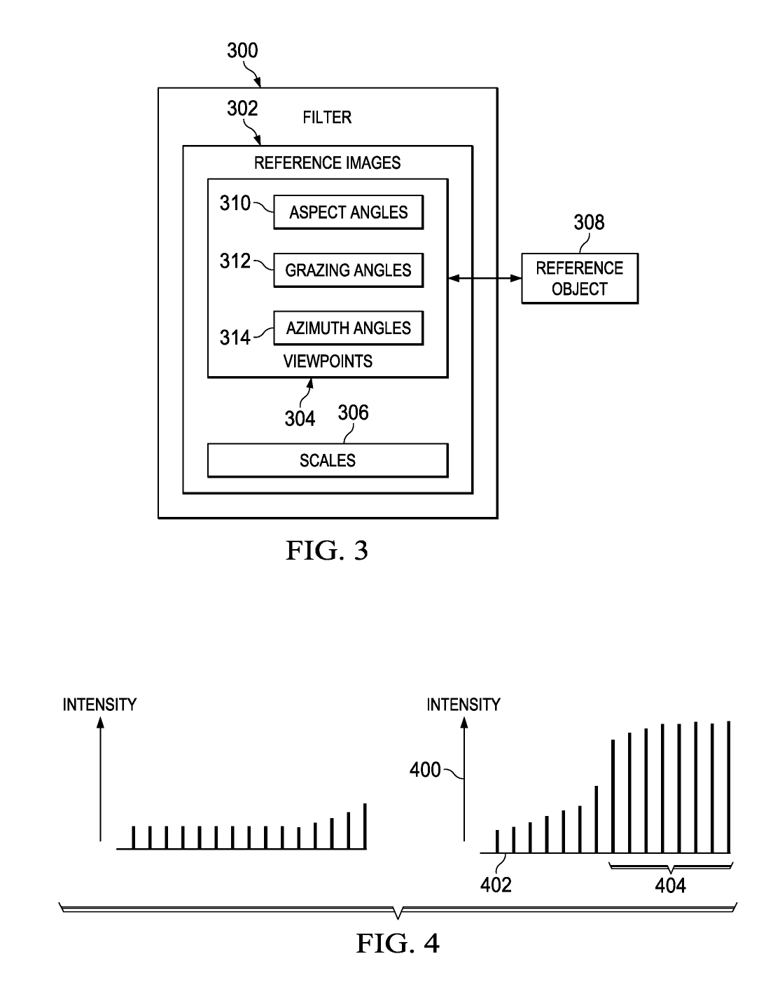

Turning now to FIG. 3, an illustration of a block diagram of reference images for a filter is depicted in accordance with an illustrative embodiment. In this illustrative example, filter 300 includes a group of reference images 302 for reference object 308. The group of reference images 302 is a portion of reference images 134, as shown in block form in FIG. 1.

The group of reference images 302 has a number of viewpoints 304 and a number of scales 306. In this illustrative example, “a number of”, when used with reference to items, means one or more items. For example, “a number of viewpoints 304” means one or more of viewpoints 304.

A viewpoint is a location of a viewer with respect to an object, such as reference object 308. The number of different viewpoints 304 provides different views of reference object 308 in reference images 302. The viewpoint may be, for example, from camera system 106, as shown in block form in FIG. 1. The number of viewpoints 304 may be represented using a range of angles selected from at least one of aspect angles 310, grazing angles 312, or azimuth angles 314.

Scales 306 are ratios of reference object 308 within reference images 302. For example, different reference images in reference images 302 have different scales 306 for reference object 308.

Multiple filters may be created with different ranges of aspect angles 310, grazing angles 312, and azimuth angles 314 for reference object 308. In other words, one or more additional filters, in addition to filter 300, may be created to recognize reference object 308. Overlaps in these ranges may be present between different filters when more than one filter is created to recognize reference object 308.

The illustration of target object recognition environment 100 and the different components in FIGS. 1-3 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, a chip may include more than one of target objects 104, as shown in block form in FIG. 1. In yet another illustrative example, object detector 200, preprocessor 202, or both may be omitted from image analyzer 108, as shown in block form in FIGS. 1-2. In this type of implementation, images or chips may be received that have been identified as containing target objects 104 for recognition, preprocessing, or some combination thereof.

In yet another illustrative example, image analyzer 108 may be located on or in communication with a platform that operates using the recognition of target objects 104. For example, the recognition of target objects 104 may be used to operate the platform. The operation may include guidance, object neutralization, or other suitable operations. The platform may be, for example, an aircraft, a spacecraft, a rocket, a missile, a satellite, a ship, or some other suitable type of platform. Further, the illustrative examples may be performed in real time as images are generated, at a later time, or some combination thereof.

With reference now to FIG. 4, an illustration of pixel intensities including a hot spot is depicted in accordance with an illustrative embodiment. In this illustrative example, y-axis 400 is intensity and x-axis 402 represents pixels with maximum values in a chip.

In this illustrative example, the number of pixels in section 404 represents a hot spot. For example, if the target object is a vehicle, this hot spot may be caused by exhaust while the engine is running and may not always be present, depending on the viewpoint.

The intensity of the pixels in section 404 may be about five to ten times greater than the intensity of other pixels for other parts of the target object. The hot spot in section 404 contains a significant part of the energy that may confuse comparator 206, as shown in block form in FIG. 2, such as when correlation-based filters, like MACH filter 216, as shown in block form in FIG. 2, are used.

The hot spot in section 404 may be removed to improve target recognition when the hot spot is present. For example, the values for pixels with the increased intensity in the hot spot in section 404 may be replaced with values from nearby pixels having a lower intensity.

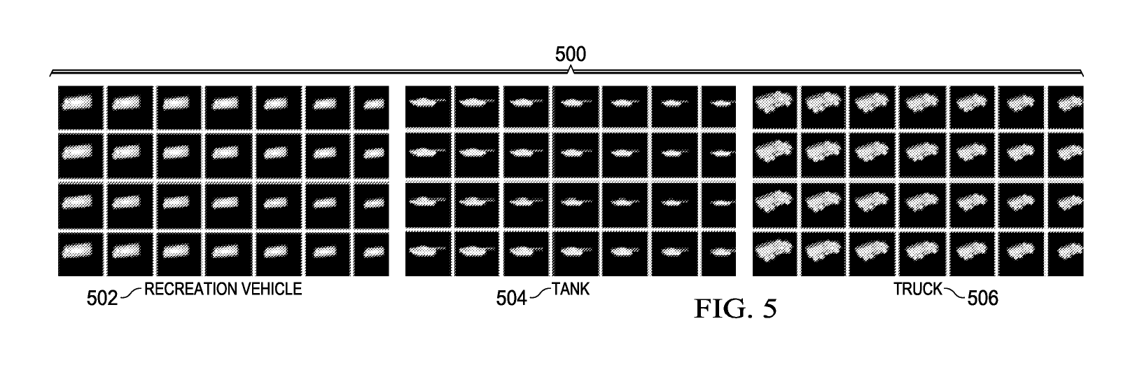

With reference now to FIG. 5, an illustration of reference images is depicted in accordance with an illustrative embodiment. In this illustrative example, reference images 500 are examples of reference images 134, as shown in block form in FIGS. 1-2, generated by filter generator 204 in image analyzer 108, as shown in block form in FIG. 2.

In this illustrative example, a group of reference images 500 is present in section 502, section 504, and section 506. The group of reference images 500 in section 502 represents a reference object in the form of a recreation vehicle. As depicted, the group of reference images 500 in section 504 represents a reference object in the form of a tank. The group of reference images 500 in section 506 represents a reference object in the form of a truck.

The groups of reference images 500 in each of the sections have at least one of different viewpoints in scales for each of the reference objects. Each of these groups of reference images 500 are used to form a MACH filter, such as MACH filter 216, as shown in block form in FIG. 2, in the illustrative examples. Each section of the group of reference images 500 may be used to create a group of filters that form a MACH filter.

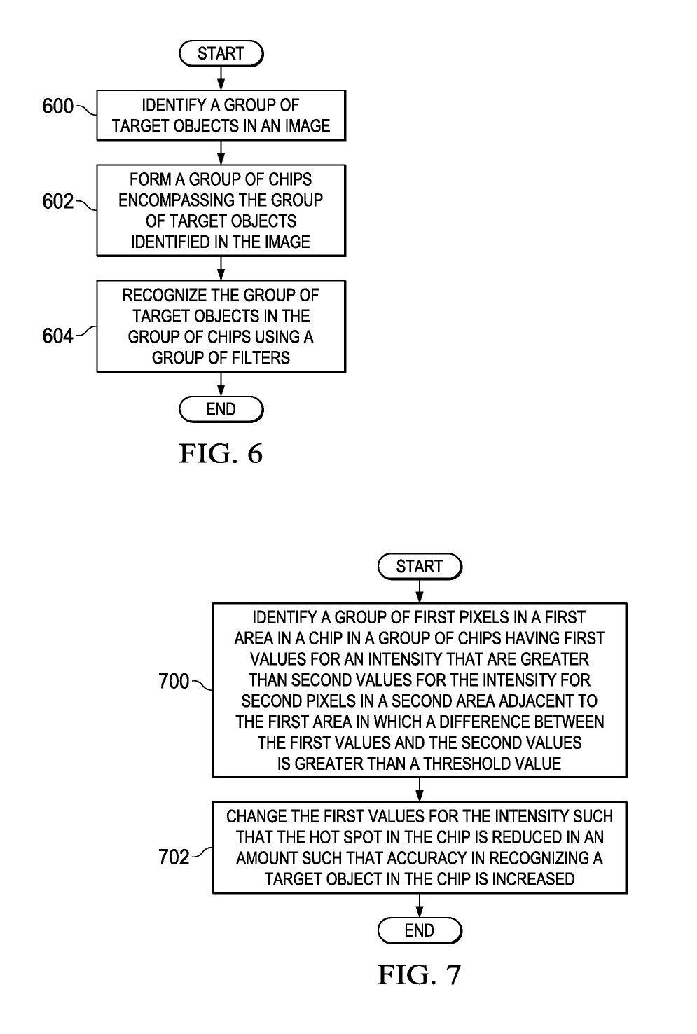

Turning next to FIG. 6, an illustration of a flowchart of a process for recognizing a target object is depicted in accordance with an illustrative embodiment. The process illustrated in FIG. 6 may be implemented in target object recognition environment 100, as shown in block form in FIG. 1. For example, the process in this flowchart may be implemented in target object recognition system 102 to recognize target objects 104, as shown in block form in FIG. 1.

The process begins by identifying a group of target objects in an image (operation 600). The process forms a group of chips encompassing the group of target objects identified in the image (operation 602). In the list of examples, each chip contains pixels for a target object.

The process recognizes the group of target objects in the group of chips using a group of filters (operation 604) with the process terminating thereafter. The group of filters is created using a group of models for reference objects and environmental information for a location where the group of target objects was located when the image was generated. A filter in the group of filters comprises a group of reference images for a reference object in the reference objects. More than one filter may be present for the reference object in which each filter covers a range of viewpoints.

With reference next to FIG. 7, an illustration of a flowchart of a process for removing a hot spot is depicted in accordance with an illustrative embodiment. The process illustrated in FIG. 7 may be implemented in image analyzer 108, as shown in block form in FIGS. 1-2. For example, the process may be implemented in preprocessor 202, as shown in block form in FIG. 2, in image analyzer 108.

The process begins by identifying a group of first pixels in a first area in a chip in a group of chips having first values for an intensity that are greater than second values for the intensity for second pixels in a second area adjacent to the first area in which a difference between the first values and the second values is greater than a threshold value (operation 700).

In operation 700, the process finds the first “N” pixels with maximum values. In operation 700, the pixels in a chip are sorted based on the values for the intensities, and the first “N” pixels with the highest values for the intensities are used. This operation may be performed sequentially. For example, operation 700 may find a maximum value first, and then find the next maximum value that is less than the previous one. The operation may be repeated until all “N” maximum values are found. These values form an array of ordered maximum intensities.

In the list of examples, the number “N” is selected to be a fraction of the total number of pixels in the chip and greater than the size of the hot spot in the chip. For example, a value of “N” may be about five percent of the total number of pixels in the chip.

The process analyzes the array of ordered maximum intensities to detect increases that are greater than a threshold value in the values of intensities from right to left in the pixels. In this illustrative example, the threshold value is selected as a ratio between the “right” and “left” pixels. When the ratio is calculated, all intensities in the chip are processed to subtract the minimum intensity value within the chip. This processing is performed such that the offset (minimum intensity) does not affect this ratio between “left” and “right” intensities. For example, referring back to FIG. 4, the distance d between two pixels in the ordered array could be from one to several pixels. If the difference between the examined pixels is greater than a specified threshold value, the pixels with the maximum values are marked as a hot spot. In this illustrative example, the specified value of the threshold value is a ratio between the intensities and may be selected from about three to about five.

The process changes the first values for the intensity such that the hot spot in the chip is reduced in an amount such that accuracy in recognizing a target object in the chip is increased (operation 702). The process terminates thereafter.

In operation 702, the process replaces the values for pixels identified in the hot spot with new values that remove the hot spot. For example, the smallest pixel value among two pixels being compared can be used as a threshold and as a value to replace all pixels intensities greater than the maximum values in the hot spot.

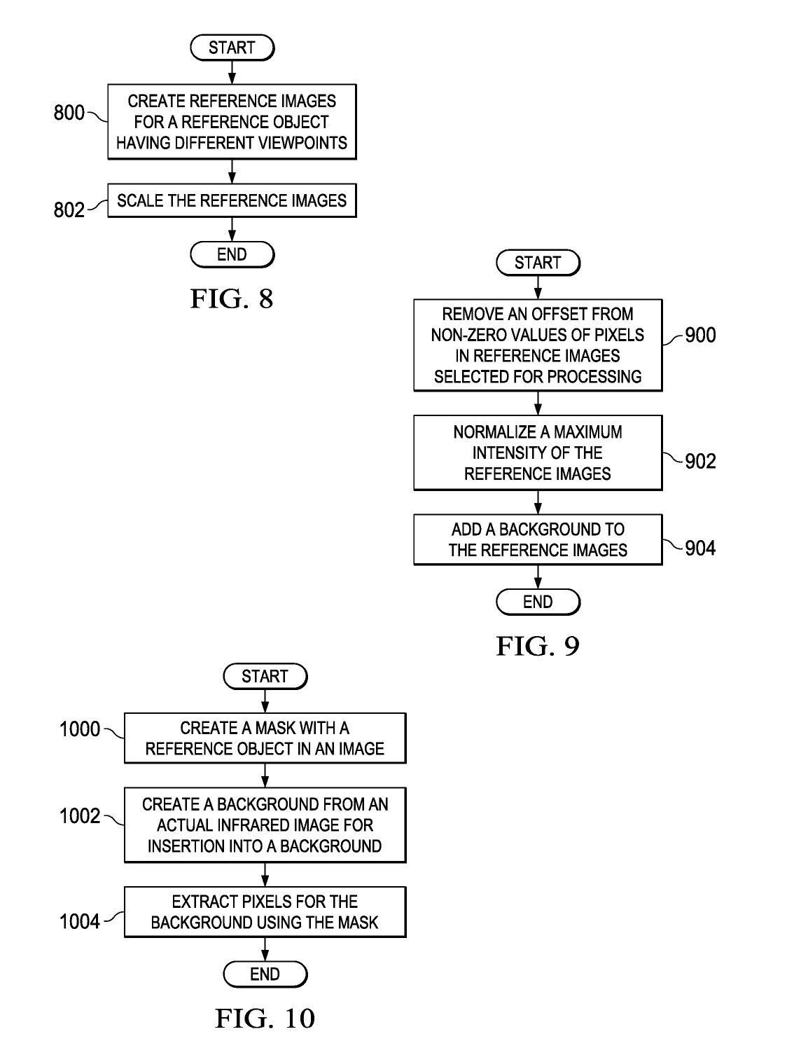

With reference next to FIG. 8, an illustration of a flowchart of a process for creating reference images for reference objects is depicted in accordance with an illustrative embodiment. In this illustrative example, the process may be implemented in filter generator 204 in image analyzer 108, as shown in block form in FIG. 2.

The process begins by creating reference images for a reference object having different viewpoints (operation 800). In operation 800, these different viewpoints may be selected based on a range of angles selected from at least one of aspect angles, grazing angles, and azimuth angles.

In other words, the process creates a variety of reference images for different viewpoints for a target object using a computer-aided design model in which the reference images represent the reference object that is used to create a filter to recognize that reference object in a chip. The reference images are generated to create multiple matched filters. Each of the matched filters may cover a range of degrees for each azimuth angle and grazing angle.

For example, the azimuth angle step for the filters is defined as:

$${S}_{a} \frac{360}{{N}_{a}} ,$$

where Sₐ is the azimuth step in degrees, and Nₐ is a number of bins in azimuth. This covers 360 degrees of possible target aspects.

The grazing angle step for the filters is defined as follows:

$${S}_{g} \frac{90}{{N}_{g}} ,$$

where S_{g} is the grazing angle step in degrees, and N_{g} is a number of bins in elevation from zero to 90 degrees.

As depicted, a corresponding matched filter is created for every combination of grazing angles and aspect angles for each target of interest. A total number of the matched filters for each target is:

Nₜ=N₉*Nₐ

The filters cover the range of angles.

The aspect angle range is identified as follows:

$${S}_{a} * {n}_{a} \pm \frac{{S}_{a}}{2} ,$$

where nₐ ∈ [0, Nₐ−1]. The grazing angle range is identified as follows:

$${S}_{g} * {n}_{g} \pm \frac{{S}_{g}}{2} ,$$

where n_{g} ∈ [0, N_{g}−1].

In this manner, the reference images for a particular filter comprise a variety of views within the ranges of the corresponding aspect angles and grazing angles. These views may be created with a fixed step in each direction, as a number of random views within the corresponding range, or in some other suitable manner. Further, each filter may have grazing ranges and aspect ranges that overlap with neighboring filters for the same reference object.

The process then scales the reference images (operation 802). The process terminates thereafter.

In operation 802, the reference images are generated for different scales of the reference object in the computer-aided design model. The scales may be generated for some or all of the different viewpoints. For example, if the original scale is 1.0, the other scales could be 0.9, 0.8, 1.1, or 1.2. The number of scales is selected to avoid mixing completely different representations of the target.

In the illustrative example, scaling the reference images aids in the performance of the MACH filters. For example, a MACH filter created for a reference object using all of the same scale may have an average precision of 0.66. In contrast, a MACH filter created for the same reference object using the same computer-aided design with scales resulted in an average precision of 0.98.

The different scales for a target object may be performed by changing the scale of the computer-aided design model. In another illustrative example, the different scales may be obtained by changing the parameters of the renderer. In addition to scale, centering of the reference object in the reference image may also be performed.

With reference now to FIG. 9, an illustration of a flowchart of a process for processing a reference image is depicted in accordance with an illustrative embodiment. The process illustrated in FIG. 9 may be implemented in filter generator 204 in image analyzer 108, as shown in block form in FIG. 2.

The process is performed using reference images created from a computer-aided design model for a reference object. These reference images with the reference object have different viewpoints and may have different scales. The process begins by removing an offset from non-zero values of pixels in reference images selected for processing (operation 900).

The process then normalizes a maximum intensity of the reference images (operation 902). Operation 902 may be performed by scanning all of the pixels of each reference image and finding the maximum value of the intensity (Iₘₐₓ(i), where i is the image number. One of the values is used as the reference (Iᵣ). The intensity of each pixel is then divided by Iₘₐₓ(i)/Iᵣ. This normalization helps ensure that all of the reference images have the same ranges of intensities.

The process then adds a background to the reference images (operation 904). The process terminates thereafter.

In operation 904, the process adds backgrounds to the reference images from actual infrared images. The actual infrared images are used to extract various backgrounds and insert them into the synthetic images around the rendered targets. In one illustrative example, these backgrounds may be from the infrared images from which comparisons are to be made to recognize target objects. In this manner, the generation and processing of reference images may be performed in real time as infrared images are received from a camera system. In other illustrative examples, the infrared images containing the backgrounds may be from a library of pre-existing infrared images. This process may be performed for each group of images for a reference object in creating a filter for the reference object.

With reference next to FIG. 10, an illustration of a flowchart of a process for adding a background to reference images is depicted in accordance with an illustrative embodiment. The process illustrated in FIG. 10 is an example of an implementation for operation 904 in FIG. 9.

The process begins by creating a mask with a reference object in an image (operation 1000). In operation 1000, the mask is used to avoid changing pixels for the target object in the reference image in when inserting background into the reference image.

In operation 1000, the mask may be generated in a number of different ways. For example, the mask may be generated by thresholding the reference image and applying morphological operations. Since the background in the rendered image is already zero, a threshold value greater than zero should provide desired results. In this example, the operation separates the reference object in the image from the background to form the mask.

Further, a morphological fill operation is performed in generating the mass to fill possible “holes” in the mask obtained after thresholding. Then, inversion of the target mask is performed to produce the mask for insertion of the background extracted from the actual infrared images.

The process creates a background from an actual infrared image for insertion into a background (operation 1002). In operation 1002, the background is scaled. The scaling is performed because actual infrared images can have a completely different intensity range compared to the intensity in the reference images. This scaling of the background is accomplished as follows:

$${P}_{bn} = K * {I}_{r} * \frac{{P}_{b} - {I}_{bmin}}{{I}_{bmax} - {I}_{bmin}} ,$$

where P_{bn} is the new value of the background pixel, K is the desired coefficient of attenuation for the background (could be from 0.1 to 0.5 and it is determined empirically for best results produced by the MACH filter classifier), Iᵣ is the reference maximum value of the intensity for all synthetic images, P_{b} is the original value of the background intensity of the current pixel, I_{bmax} is the maximum value of the background intensity, and I_{bmin} is the minimum value of the background intensity. In this illustrative example, the normalization of the background pixels described above is applied for the background pixels selected for the insertion and is specified in the mask.

The process then extracts pixels for the background using the mask (operation 1004). This mask is applied to extract a set of background pixels from the actual infrared images and to insert them into the reference images. In this manner, a set of backgrounds is used to increase the variability of the reference training images to make the classifier more robust.

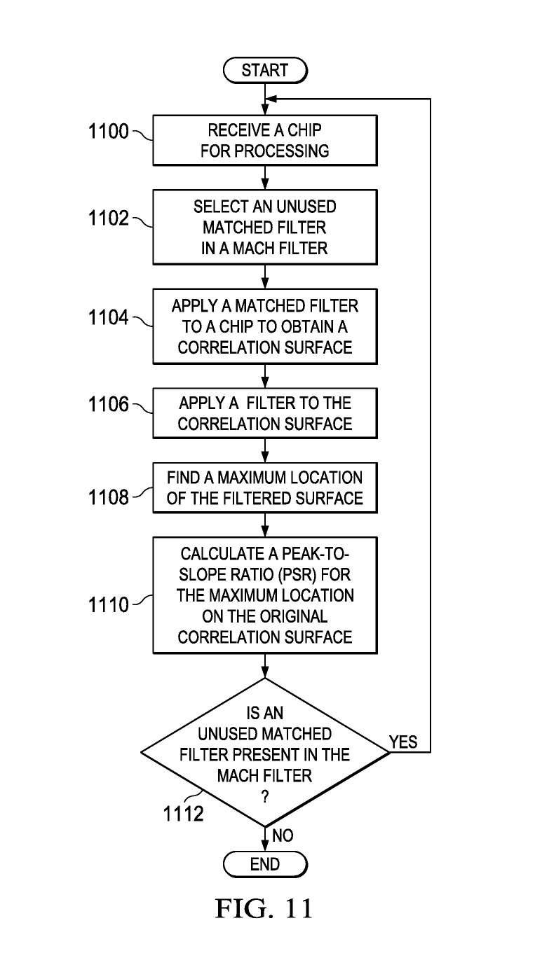

With reference next to FIG. 11, an illustration of a flowchart of a process for processing a chip in a MACH filter is depicted in accordance with an illustrative embodiment. The process illustrated in FIG. 11 may be implemented in filter system 222 in comparator 206 located in image analyzer 108, as shown in block form in FIG. 2. In this illustrative example, comparator 206 may be a classifier for target object recognition. The process illustrated in FIG. 11 is an example of one manner in which target object recognition may be performed in comparator 206.

The process begins by receiving a chip for processing (operation 1100). The process then selects an unused matched filter in a MACH filter (operation 1102). An unused matched filter is one that has not been applied to the chip received for processing.

The process applies a matched filter to a chip to obtain a correlation surface (operation 1104). In the illustrative example, the matched filter works like a correlator. By applying the matched filter, the chip is processed using the matched filter to obtain the correlation surface. In some cases, the correlation surface may be called a correlation plane. In the illustrative example, all of the matched filters are applied to the same chip to generate the correlation surface for each of the matched filters.

The process then applies a filter to the correlation surface (operation 1106). In operation 1106, the filter is a two-dimensional finite input response (FIR) filter. The filter is selected to reduce the impact of coincidental coherence that creates sharp and narrow peaks on the correlation surface. In this manner, a reduction of false results produced by the matched filter occurs. The reduction of false results provides increased accuracy in recognizing target objects. The process finds a maximum location of the filtered surface (operation 1108). The maximum location provides the location of maximum correlation of the chip to the reference object with the corresponding matched filter.

The process then calculates a peak-to-slope ratio (PSR) for the maximum location on the original correlation surface (operation 1110). Although a peak-to-slope ratio is calculated in operation 1110, other types of calculations also may be used in other implementations. For example, a peak-to-correlation energy may be used. The peak-to-slope ratio is the output value that indicates a likelihood that a target object in a chip is the reference object represented by the filter.

The process determines whether an unused matched filter is present in the MACH filter (operation 1112). If an unused matched filter is present, the process returns to operation 1100. Otherwise, the process terminates.

The process in FIG. 11 varies from currently used processes for filtering chips. For example, a two-dimensional finite input response filter is applied to the correlation surface generated from first applying the matched filter to the chip. This additional filter provides improved results. In the illustrative example, the additional filter is used to remove sharp peaks that are caused by noise. The real correlation peaks are much wider and more reliable than the peaks caused by noise.

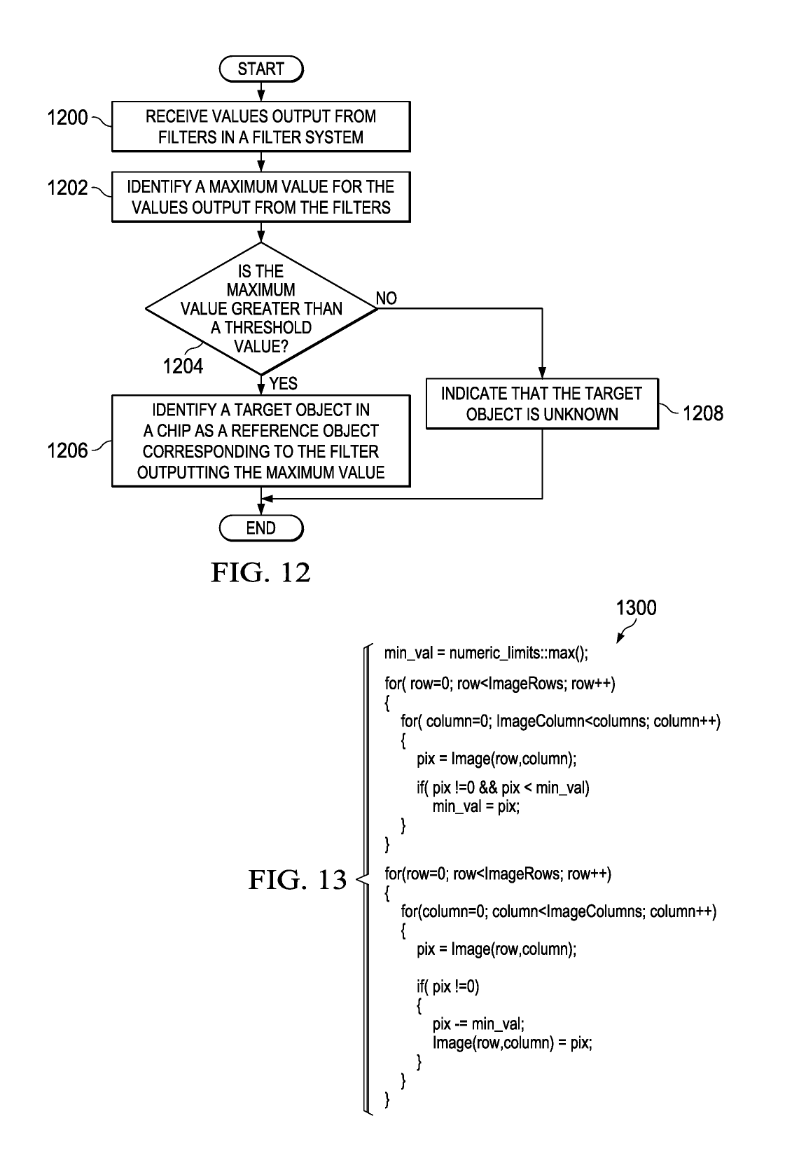

With reference now to FIG. 12, an illustration of a flowchart of a process for recognizing a target object is depicted in accordance with an illustrative embodiment. The process illustrated in FIG. 12 may be implemented in object identifier 224 in comparator 206 located in image analyzer 108, as shown in block form in FIG. 2. The process in this flowchart may use values output in operation 1110 in the flowchart in FIG. 11.

The process begins by receiving values output from filters in a filter system (operation 1200). The process identifies a maximum value of the values output from the filters (operation 1202). The process determines whether the maximum value is greater than a threshold value (operation 1204).

If the value is greater than a threshold value, the process identifies a target object in a chip as a reference object corresponding to the filter outputting the maximum value (operation 1206) with the process terminating thereafter. With reference again to operation 1204, if the maximum value is not greater than a threshold value, the process indicates that the target object is unknown (operation 1208) with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, filters may be created dynamically as information about the environment is received. For example, reference images for different viewpoints and different scales for reference objects may be generated ahead of time and placed into filters. These reference images are modified using the environmental information.

As another example, the determination in operation 1204 may be whether the maximum value is equal to or greater than a threshold value. This type of determination may be made based on the manner in which the threshold value is selected and defined.

With reference next to FIG. 13, an illustration of pseudocode for removing non-zero values of pixels in a reference image is depicted in accordance with an illustrative embodiment. In this illustrative example, pseudocode 1300 may be implemented in filter generator 204 in image analyzer 108, as shown in block form in FIG. 2.

Pseudocode 1300 is an example of code for a process to remove an offset from non-zero values of the pixels in a reference image and may be used to implement operation 900 in FIG. 9. Pseudocode 1300 scans the image pixels two times. During the first scan, the procedure finds the offset of non-zero pixels by processing only pixels with a positive intensity value and finding a minimum non-zero intensity for these values. During the second scan of the image pixels, the offset is subtracted from non-zero pixels only. Each of the reference images may be processed using pseudocode 1300.

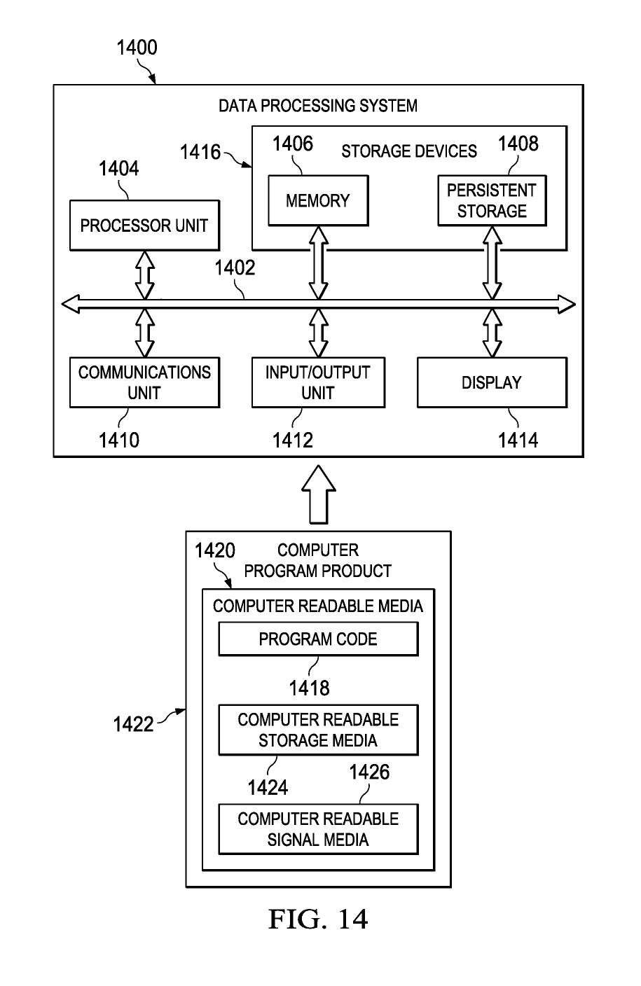

Turning now to FIG. 14, an illustration of a block diagram of a data processing system is depicted in accordance with an illustrative embodiment. Data processing system 1400 may be used to implement computer system 140, as shown in block form in FIG. 1. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 may take the form of a bus system.

Processor unit 1404 serves to execute instructions for software that may be loaded into memory 1406. Processor unit 1404 may be a number of processors, a multi-processor core, or some other type of processor, depending on the particular implementation.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer readable storage devices in these illustrative examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a solid state hard drive, a flash memory, a rewritable optical disk, a rewritable magnetic tape, or some combination of the above. The media used by persistent storage 1408 also may be removable. For example, a removable hard drive may be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that may be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs may be located in storage devices 1416, which are in communication with processor unit 1404 through communications framework 1402. The processes of the different embodiments may be performed by processor unit 1404 using computer-implemented instructions, which may be located in a memory, such as memory 1406.

These instructions are referred to as program code, computer usable program code, or computer readable program code that may be read and executed by a processor in processor unit 1404. The program code in the different embodiments may be embodied on different physical or computer readable storage media, such as memory 1406 or persistent storage 1408.

Program code 1418 is located in a functional form on computer readable media 1420 that is selectively removable and may be loaded onto or transferred to data processing system 1400 for execution by processor unit 1404. Program code 1418 and computer readable media 1420 form computer program product 1422 in these illustrative examples. In one example, computer readable media 1420 may be computer readable storage media 1424 or computer readable signal media 1426. In these illustrative examples, computer readable storage media 1424 is a physical or tangible storage device used to store program code 1418, rather than a medium that propagates or transmits program code 1418.

Alternatively, program code 1418 may be transferred to data processing system 1400 using computer readable signal media 1426. Computer readable signal media 1426 may be, for example, a propagated data signal containing program code 1418. For example, computer readable signal media 1426 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1400 are not meant to provide architectural limitations to the manner in which different embodiments may be implemented. The different illustrative embodiments may be implemented in a data processing system including components in addition to or in place of those illustrated for data processing system 1400. Other components shown in FIG. 14 can be varied from the illustrative examples shown. The different embodiments may be implemented using any hardware device or system capable of running program code 1418.

Thus, the illustrative examples provide a method and apparatus for recognizing target objects in images such as infrared images or other types of images. One or more of the illustrative examples include technical solutions that overcome a technical problem recognizing target objects in infrared images as accurately as desired when many different types of target objects are possibly present. Further, one or more illustrative examples also include technical solutions that overcome a technical problem with the amount of training data needed to enable a target recognition system to perform in a manner that provides a desired level of target object recognition, while reducing false alarms when recognizing target objects in infrared images.

For example, an illustrative example generates reference images that take into account environmental information about the environmental conditions present when the images of the target objects were generated. Further, other technical solutions are present and may be used, including removing hot spots, selecting ranges of viewpoints and scaling, as well as other operations performed in creating reference images. These and other technical solutions described in the illustrative examples help overcome one or more of the technical problems present with currently used techniques for recognizing target objects in infrared images.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
an object detector that identifies a group of target objects in an image and forms a group of chips encompassing the group of target objects identified in the image;
a filter system including a group of filters created using a group of models for a group of reference objects and environmental information for a location where the group of target objects was located when the image was generated, wherein a filter in the group of filters comprises a group of reference images for a reference object in the group of reference objects; and
an object identifier that recognizes the group of target objects in the group of chips using the group of filters.

2. The apparatus of claim 1 further comprising:
a preprocessor that removes hot spots from the group of chips prior to the group of chips being processed by the filter system.

3. The apparatus of claim 2, wherein in removing the hot spots from the group of chips prior to the group of chips being processed by the filter system, the preprocessor identifies a group of first pixels in a first area in a chip in the group of chips as a hot spot having first values for an intensity that is greater than second values for the intensity for second pixels in a second area adjacent to the first area in which a difference between the first values and the second values is greater than a threshold and changes the first values for the intensity such that the hot spot in the chip is reduced in an amount such that accuracy in recognizing a target object in the chip is increased.

4. The apparatus of claim 1 further comprising:
a camera system that generates the image by detecting at least one of infrared light, visible light, or ultraviolet light.

5. The apparatus of claim 1 further comprising:
a filter generator that creates the group of filters using the group of models for the group of reference objects and the environmental information for the location where the group of target objects was located when the image was generated, wherein the filter in the group of filters has the group of the reference images.

6. The apparatus of claim 5, wherein the group of reference images for each filter in the group of filters has a number of viewpoints.

7. The apparatus of claim 1, wherein the group of reference images for each filter in the group of filters has a number of scales.

8. The apparatus of claim 5, wherein in creating the group of filters using the group of models for the group of the reference objects and the environmental information for the location where the group of target objects was located when the image was generated, the filter generator creates a reference image in the group of reference images including the reference object; creates a mask with the reference object in the reference image; and adds a background in the reference image using the mask.

9. The apparatus of claim 1, wherein in recognizing the group of target objects in the group of chips using the group of filters, the object identifier outputs a group of values from the group of filters for a chip in the group of chips to form the group of values; identifies a maximum value from the group of values; and assigns a classification associated with the filter outputting the maximum value to a target object in the chip when the maximum value is greater than a threshold value.

10. The apparatus of claim 1, wherein the group of filters is a maximum average correlation height filter.

11. The apparatus of claim 1, wherein the group of models is a group of computer-aided design models.

12. A method for recognizing target objects comprising:
identifying a group of target objects in an image;
forming a group of chips encompassing the group of target objects identified in the image; and
recognizing the group of target objects in the group of chips using a group of filters, wherein the group of filters is created using a group of models for reference objects and environmental information for a location where the group of target objects was located when the image was generated, wherein a filter in the group of filters comprises a group of reference images for a reference object in the reference objects.

13. The method of claim 12 further comprising:
creating the group of filters using the group of models for the reference objects and the environmental information for the location where the group of target objects was located when the image was generated, wherein the filter in the group of filters comprises the group of reference images for a reference object in the reference objects.

14. The method of claim 12 further comprising:
removing hot spots from the group of chips.

15. The method of claim 14, wherein a removing step comprises:
identifying a group of first pixels in a first area in a chip in the group of chips as a hot spot having first values for an intensity that is greater than second values for the intensity for second pixels in a second area adjacent to the first area in which a difference between the first values and the second values is greater than a threshold value; and
changing the first values for the intensity such that the hot spot in the chip is reduced in an amount such that accuracy in recognizing a target object in the chip is increased.

16. The method of claim 12 further comprising:
generating the image using a camera system that detects at least one of infrared light, visible light, or ultraviolet light.

17. The method of claim 13, wherein the creating step comprises:
creating the group of filters comprising the group of reference images using the group of models for the reference objects, wherein the group of reference images for each filter in the group of filters has a number of viewpoints.

18. The method of claim 13, wherein the creating step comprises:
creating the group of filters comprising the group of reference images using the group of models for a group of reference objects, wherein the group of reference images for each filter in the group of filters has a number of scales.

19. The method of claim 13, wherein the creating step comprises:
creating a reference image including the reference object;
creating a mask with the reference object in the reference image; and
adding a background in the reference image using the mask.

20. The method of claim 12, wherein a recognizing step comprises:
outputting a group of values from the group of filters for a chip in the group of chips to form the group of values;
identifying a maximum value from the group of values; and
assigning a classification associated with the filter outputting the maximum value to the target object in the chip when the maximum value is greater than a threshold value.

21. The method of claim 12, wherein the group of filters is a maximum average correlation height filter.

22. An automatic object identifier system comprising:
a potential object detector that receives an infrared image from a camera system and identifies a group of target objects in an image and forms a group of chips encompassing the group of target objects identified in the image;
a preprocessor that removes hot spots from the group of chips;
a filter system that receives the image from the preprocessor after the hot spots are removed from the group of chips and outputs a group of values from a group of filters for each chip in the group of chips, wherein the filter system includes the group of filters created using a group of models for reference objects and environmental information for a location where the group of target objects was located when the image was generated and wherein a filter in the group of filters comprises a group of reference images for a reference object in the reference objects; and
an object identifier that recognizes a target object in the chip using the group of values output by the group of filters.
